(19) United States
(12) Patent Application Publication
(10) Pub. No.: US 2026/0131537 A1
(43) Pub. Date: May 14, 2026

(54) COURSE CORRECTED ROBOTIC ARM

(71) Applicant: Desktop Metal, Inc.

(72) Inventors: Thane HUNT, Burlington, MA (US); Aaron PRESTON, Bedford, MA (US)

(21) Appl. No.: 19/121,809

(22) PCT Filed: Oct. 18, 2023
(86) PCT No.: PCT/US2023/077226

§ 371 Date: Apr. 17, 2025

Related U.S. Application Data
(60) Provisional application No. 63/417,091, filed on Oct. 18, 2022.

(51) Int. Cl. B29C 64/393; B29C 64/165; B33Y 30/00; B33Y 50/02

(52) U.S. Cl. CPC B29C 64/393; B29C 64/165; B33Y 30/00; B33Y 50/02

(57) ABSTRACT

Embodiments relate to methods for course correction of a robotic arm in 3D printing applications involves applying arbitrary offsets along X-, Y-, Z-, and theta Z-axes, enabling correction of arbitrary repeatable errors in the arm's nominal (uncorrected) trajectory. By applying those offsets in the reverse, their effects can be cancelled or reduced to achieve repeatable near-planarity in the path of travel.

### CROSS-REFERENCE TO RELATED APPLICATIONS

This application is a US National Stage application, filed under 35 U.S.C. § 371, of International Application PCT/US 2023/077226, filed Oct. 18, 2023, and claims priority to U.S. Provisional Application No. 63/417,091, filed Oct. 18, 2022, the contents of the above-mentioned applications are incorporated herein by reference in their entirety.

### SUMMARY

The present disclosure relates to a method for course correction of a robotic arm typically implemented for 3D printing applications. In particular, disclosed embodiments includes measuring a tool center point (TCP)'s pose relative to a global build volume coordinate system and corrects position and orientation errors. When printing a layer of a 3D-printed object, the path trajectory of the robotic arm is composed of multiple waypoints. At least one embodiment of the present disclosure can reduce error in the path trajectory of the robotic arm. Errors in the path may be corrected by controlling the robotic arm so that it moves through a slight, compensatory curve to account for deviations between a planned and an executed path in X-, Y-, Z- or theta-Z directions. For purposes of this application, the X direction may also be characterized as the “travel direction”; the Y direction may also be characterized as the “transverse direction”; and the Z direction may also be characterized as the “layering direction”. The theta-Z direction may be understood as the twist between the end effector and the end of the robot arm, such as when the primary axes of a recoater blade (or bank of printheads) are out of parallel with the transverse direction of a global coordinate system. Theta-Z deviation may be described as “yaw” orientation error of a robotic arm's TCP relative to a build volume coordinate system and, for purposes of this application, may be characterized as the “twist direction”. Embodiments of the present disclosure include tracking the position and orientation of the robotic arm's TCP relative to the global coordinate system to determine a repeatable offset that is characteristic of a robotic arm, A spline is traced through the robotic arm's waypoints, thereby establishing a command trajectory for the arm's TCP. For each waypoint, arbitrary offsets which describe the full pose of the TCP can be applied, enabling correction of arbitrary repeatable errors in the arm's nominal (uncorrected) trajectory. For example, the offsets from the expected path along the Z-direction are observed to be one or more curve points and one or more backlash points typically in the middle of the full path of travel in the X or Y axis. By applying those offsets in the reverse, their effects can be cancelled or minimized to achieve repeatable near-planarity in the path of travel in the X or Y direction.

### BACKGROUND

It is desired for certain robot arms (also referred to as ‘arms’ or “robots’ in this application), such as IRB 660 robot arms (produced by ABB, Zurich, Switzerland), to move across and/or along a 2500 mm line in the travel axis (horizontal, print direction) with no more than +/−0.1 mm of deviation in the layering axis (vertical) while loaded with a payload and at speeds of approximately 325 mm/s. The ABB IRB 460 and 660 robots can exhibit up to 1 mm of Z deviation during this movement. The weight of the payload varies over time in a consistently cyclic manner. This can happen, for example, when 6-7 L-10 kg of due build material is fetched and dispensed over approximately 6-7 layers and refilled. Such cyclic loading can result in deviations along the layering axis, causing subsequent layers printed after a material fetch to be smaller in height (as evidenced by the arm's TCP in the layering direction being lower than expected). The ABB “absolute accuracy” option is not available for the IRB 660 robots (they are palletizing robots-not designed to be as precise).

The IRB 660 robot arms are four-axis robotic arms that are relatively inexpensive compared to other robotic arms in the marketplace. While such robot arms may be highly accurate in attaining certain static positions at the start and end of motion, navigation proceeding between these static positions (e.g., passing through points in while in motion motion) is less accurate and can include significant variation (e.g., +/−mm or more). This can present particular problems in the context of 3D printing, wherein the path or a robotic arm from start to end point can have a significant impact on overall build quality. To further illustrate the particular problems, and in a non-limiting example, a robot arm purposed and employed to move an object from a first point in space to a second point in space may execute a motion along a planned path connecting the first and second points in space and may further deviate from the planned path while accomplishing the desired purpose. In contrast, such applications may be wholly unacceptable in a 3D printing application where positions of a robot are required to maintain a set (or guaranteed) amount of accuracy during an entire motion, not just at starting and ending points-thus, a deviation in position between a planned path and an actual path during the motion may result in significant errors.

Sample data collected and presented in FIG. 1 below is captured using a Leica 3D Tracker illustrating an ABB Robot arm's deviation from an ideal straight line during a printing movement. The IRB 460 robot deviated by about 800 microns in the vertical (layering) axis (Z position in FIG. 1) while moving across a ˜2000 mm path along the travel axis.

Additionally, there is a higher frequency component of motion occurring at the inflection points of the layering and travel axes during the straight-line motion. Additionally, a “backlash bump” present between travel position locations 900 and 1400 mm (Y position in FIG. 1) varies in magnitude with the payload speed. The backlash bump error may result from the change in direction of one of the robot joints—that is, a direction of motion (linear or rotational) may reverse and result in an undesirable position deviation.

### Observation 1—The Magnitude of the Backlash Error Grows as a Function of TCP Speed

The ABB IRB 460 and 660 arms have a backlash magnitude of approximately −02 mm in Z direction at the typical printing speed of 325 mm/s. At 100 mm/s, the error is reduced about 50% to around −0.1 mm. At 20 mm/s the error vanishes. The overall curvature of motion appears unrelated to TCP speed. This application moves the arm at 325 mm/s. so we see −0.25 mm of Z deviation in the center of the movement profile. Moving at 20 mm/s is not a viable option for many applications, as the speed is too slow to enable economic processing. A graph depicting evidence of this observation can be found in FIG. 1.

### Observation 2—The Robot Path Profile (Curvature and Backlash) is Consistent at Different TCP Z Heights

The ABB IRB 460 and 660 robot arms showed a nearly identical Z vs. Y profile through all sampled print heights. The sampled range showed no signs of shifting or scaling. This suggests that the behavior is not random and so a single calibration profile could be used throughout the entire height, A graph depicting evidence of this observation can be found in FIG. 2.

At least one embodiment of the present disclosure provides a unique motion correction that improves upon the deficiencies in state of the art robotic arms, such as those of ABB.

### BRIEF DESCRIPTION OF THE DRAWINGS

FIG. 1 depicts Z vs Y profiles at different Y-axis velocities.

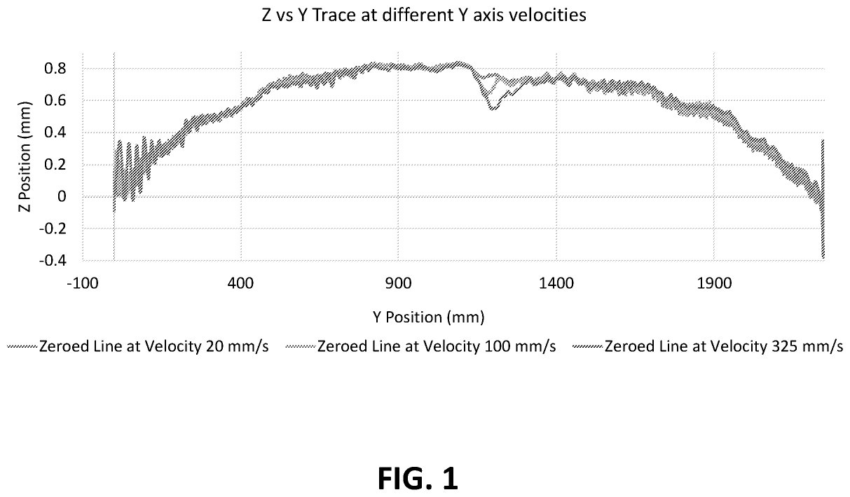

FIG. 2 depicts Z vs Y profiles at different Z heights.

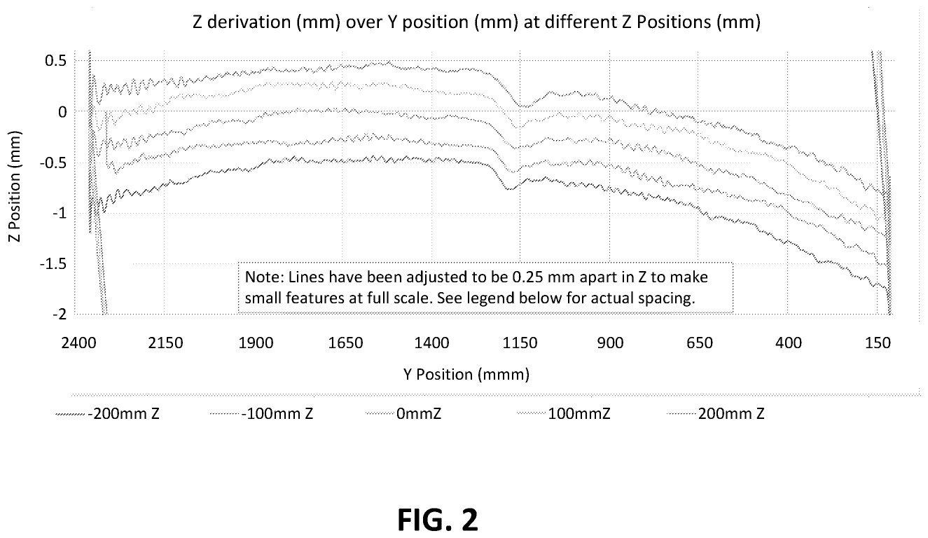

FIG. 3 depicts an exaggerated scale depiction of the straightness compensation toolpath (shown in red line).

FIG. 4 depicts the geometric control points of motion correction.

FIG. 5 depicts a robot's motion profile with and without correction.

FIG. 6 depicts a robot's commanded path profile without correction. Note: a straight line motion of a final path trajectory is desired. Not all milestones of a splined trajectory are shown.

FIG. 7 depicts a robot's commanded path profile with correction (scaled for visibility). Note: a straight line motion of a final path trajectory is desired. Not all milestones of a splined trajectory are shown.

FIG. 8 depicts collected data from the robot with and without correction where an additional correction for skew has not been applied. In these data, a correction for the backlash bump has also been omitted. The position data corresponds to the layering (Z) and travel (Y) positions.

FIG. 9 depicts a robotic arm with a print engine where course correction could be implemented.

FIG. 10 depicts an end effector (including print head bank, recoating blade, and microhopper) mounted on a robot arm. The microhopper mounts include a load cell to monitor an amount of build material within the microhopper, to at least sense the amount of build material during a printing operation. The knuckle joint is configured to enable rotation of the end effector relative to the robot arm. The TCP is illustrated on the end effector, and may constitute the location of a coordinate system for the end effector.

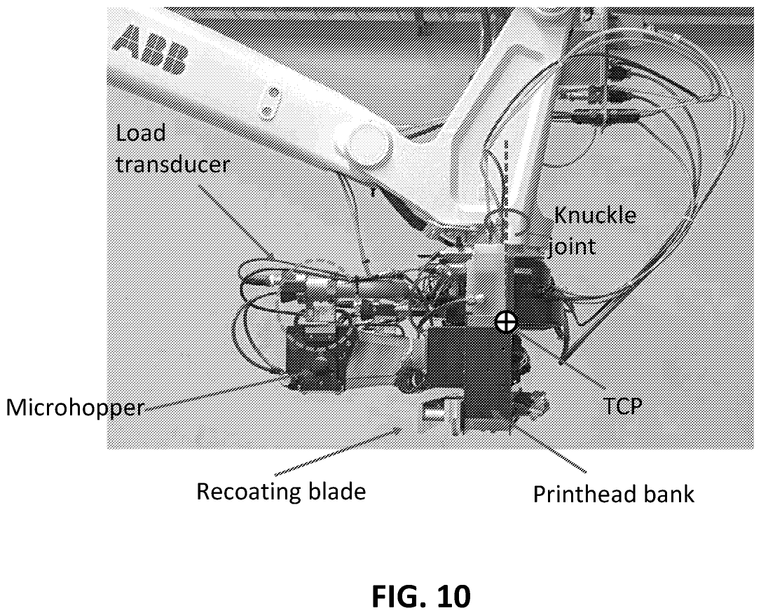

FIG. 11 A-C depict a buildbox surface where a reference object is placed. In certain embodiments, the build box at least partially defines a build volume. The loadcells are in view for load-based compensation.

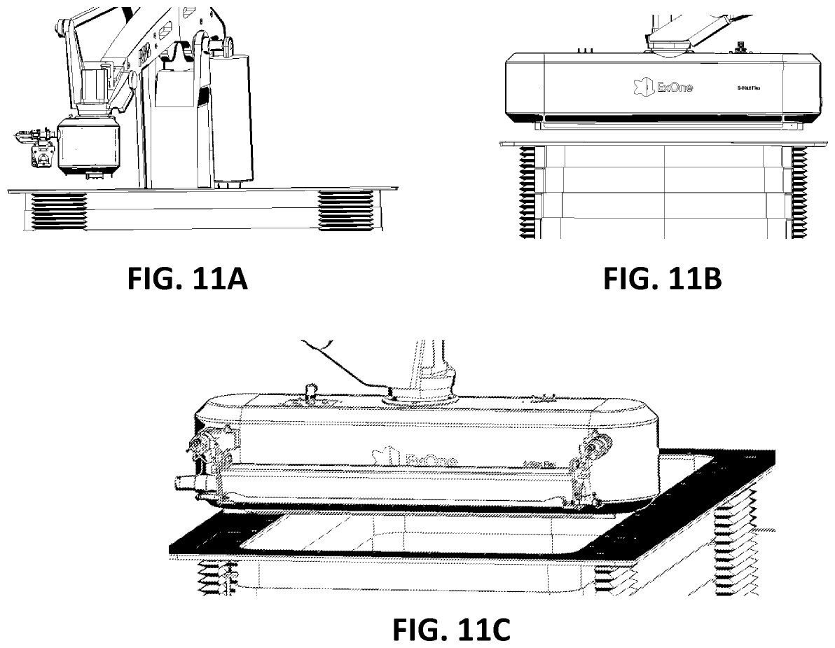

FIG. 12 depicts overview of X/Z trajectory error measurements relative to a reference object. The purple box represents the print head. The green symbol represents an X-deviation linear measurement. The orange symbol represents a Z-deviation linear measurement. The red box represents a buildbox top surface. And the blue box represents a reference object fixed to the red buildbox.

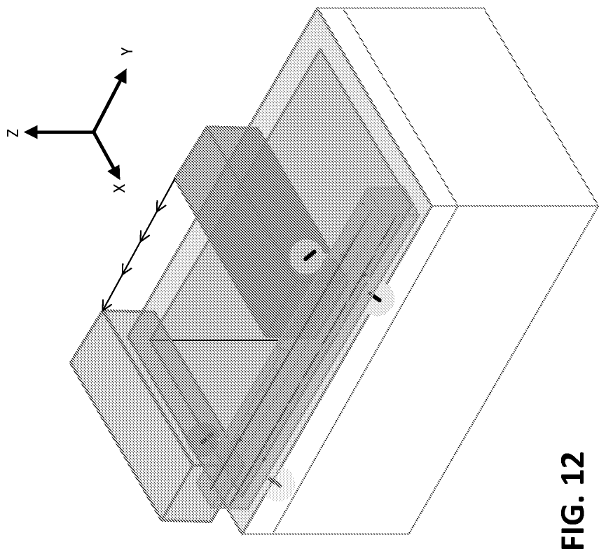

FIG. 13 depicts an example of a dataset where Y-deviation is inferred based on a reference object. FIG. 13 is a schematic illustration of a reference object (straightedge) over which an indicator attached to a robot arm may be moved. The test indicator moves along a direction of travel and should reproduce measurements of (1) a profile corresponding to the profile of the reference object (a line in this instance), and (2) several perturbations at fixed and known locations corresponding to reference fiducials placed along the straightedge in the direction of travel. In this way, deviations in the position of the robot in transverse direction are characterized by the measurement (I) at positions along the travel direction with waypoints provided by the perturbations in (2). This procedure may be repeated (or simultaneously collected) for the spare indicators to show deviations in the layering position along the travel direction.

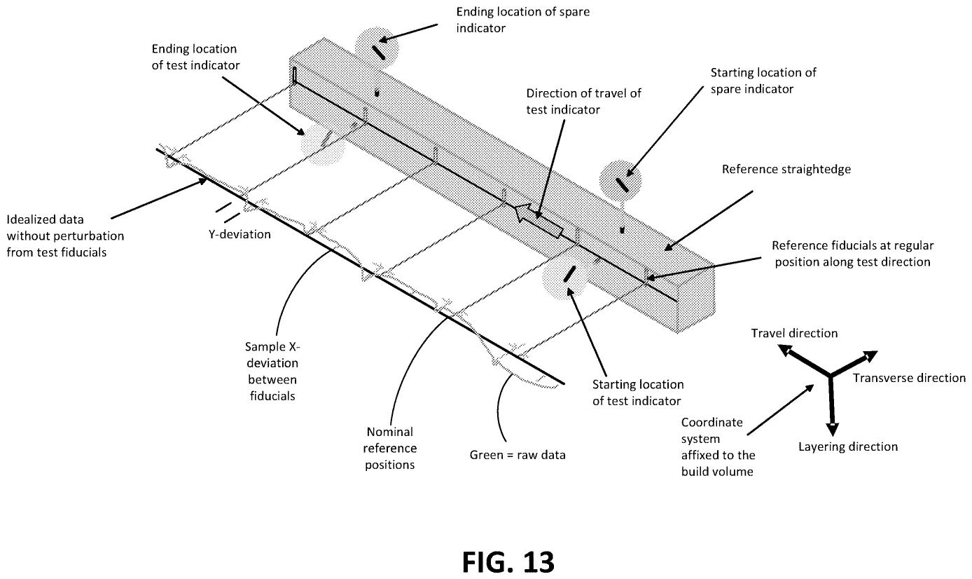

FIG. 14 depicts an example of a reference object (a 6-foot straight edge with flat surfaces in XY and YZ planes).

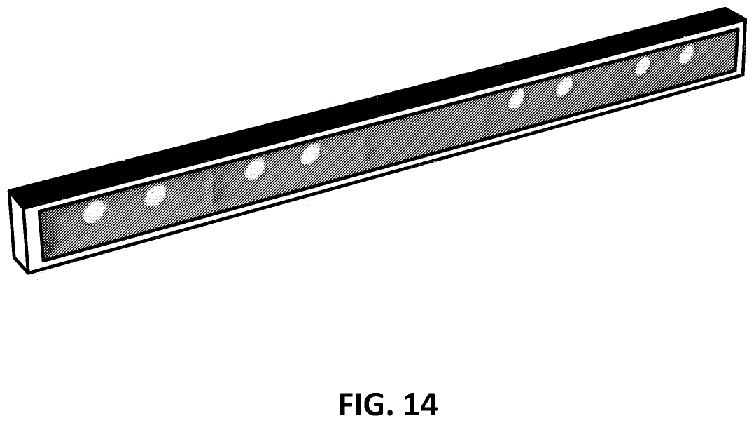

FIG. 15 depicts a graph showing example measurement errors introduced by a linear measurement device not being normal to a reference plane in which small alignments are acceptable.

FIG. 16 depicts an example of a skewed part due to a theta-Z error, where the error is assumed constant over the print pass.

FIG. 17 A depicts a printhead orientation relative to a knuckle axis. FIG. 17B depicts an example measurement strategy to characterize yaw error of a TCP relative to a global coordinate system.

FIG. 18 depicts TCP and Build Volume Coordinate Systems and rotations about the primary transverse, travel, and layering axes (pitch, roll, and yaw, respectively). These coordinate systems align with typical aircraft conventions for orientation.

### DETAILED DESCRIPTION

At least one embodiment of the present disclosure provides for course correction in the path trajectory of robotic arms. The 4DOF robot S-Max flex employs a TCP that is fully defined by translations along transverse, travel, and layering axes in addition to a yaw orientation of a printbeam connection (known as a knuckle joint). At least six degrees of freedom are required to enable a robot hand to reach an arbitrary pose with respect to position and orientation.

With respect to terminology in this application, “position” refers to translation along the X (“transverse”), Y (“travel”), and Z (“layering”) axes, respectively. “Orientation” refers to rotation about the primary axes: “pitch” refers to rotation about the X-axis; “roll” refers to rotation about the Y-axis; and “yaw” refers to rotation about the Z-axis. “Pose” refers to a folly-defined position of the TCP (defining all six degrees of freedom).

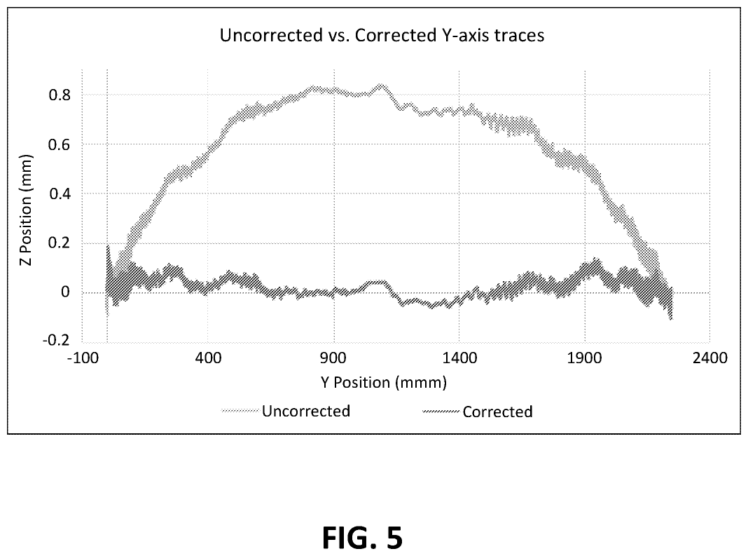

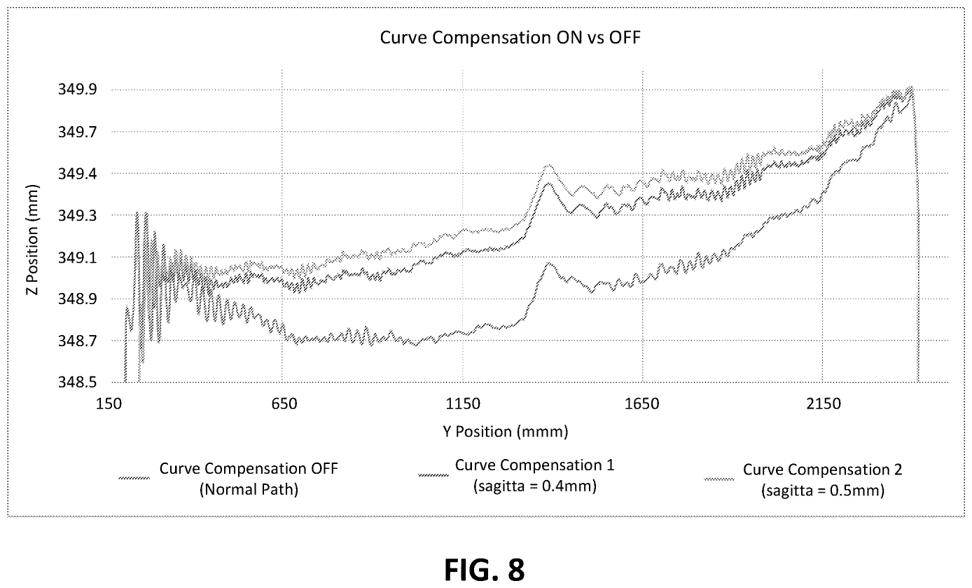

In addition, the following definitions are provided for context for this application:
Build volume: maximum addressable volume (XYZ) in which the parts can be printed within a system. For purposes of the present disclosure, path correction may be most important within this volume.
Global coordinate system—a build volume reference frame. Where printed parts are located, this system is fixed relative to the base frame of a robot.
Skew correction—angled data, resulting from orientation misalignment between TCP and global coordinate systems. FIGS. 5 and 8 provide examples of skew error correction.
Load Transducer an Arbitrary Analog Device Which Reports Load Values
Knuckle joint—a final joint axis coincident with the TCP layering axis. The knuckle joint controls yaw orientation of the TCP.
Microhopper—small batches of build material are loaded into a small trough known as a microhopper, which controls the deposition rate of material during print pass. The microhopper is refilled periodically during the printing process from bulk storage.
Recoater blade—spreads and compacts build material dispensed from the microhopper. Blade orientation (specifically pitch, yaw) are critical to control relative to the global coordinate system. By way of example, yaw orientation error of the bar relative to the TCP are compensated for via path correction strategies.

By way of example, a TCP deflection along the Z-axis may be quantified for an arm, as deflection as a function of applied load, which typically amounts to ˜10 μm/kg. This value may be characterized as a function of the X-, Y-, and Z-positions and noted to be uniform throughout build volume, thus simplifying correction of any axes' deviations. At each layer, current end-effector load may be queried by loadcells that support a sand microhopper. Based on these measurements (taken when TCP velocity equals zero), a fixed Z-direction offset may be applied uniformly to all waypoints in the robotic arm to correct for load-based deflection. Such deflection may be assumed constant throughout each layer.

In another embodiment, mass flowrate may be calculated throughout a layer trajectory and each waypoint along the print direction corrected based on the predicted load locally at each Y position.

Path profile and backlash correction offsets may be applied on top of load-based Z-direction compensation.

Deviations in path trajectory are corrected by controlling the arm to move through a slight, compensatory curve to account for deviations in the X-, Y-, Z-, or theta-Z directions.

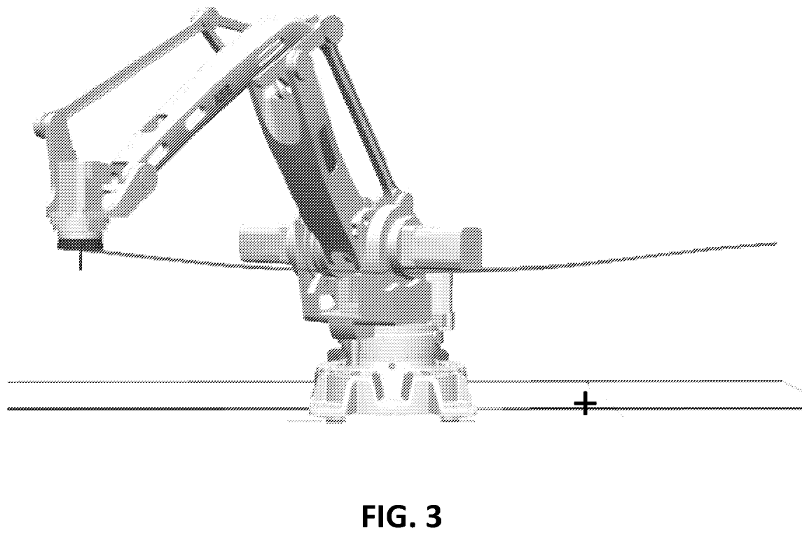

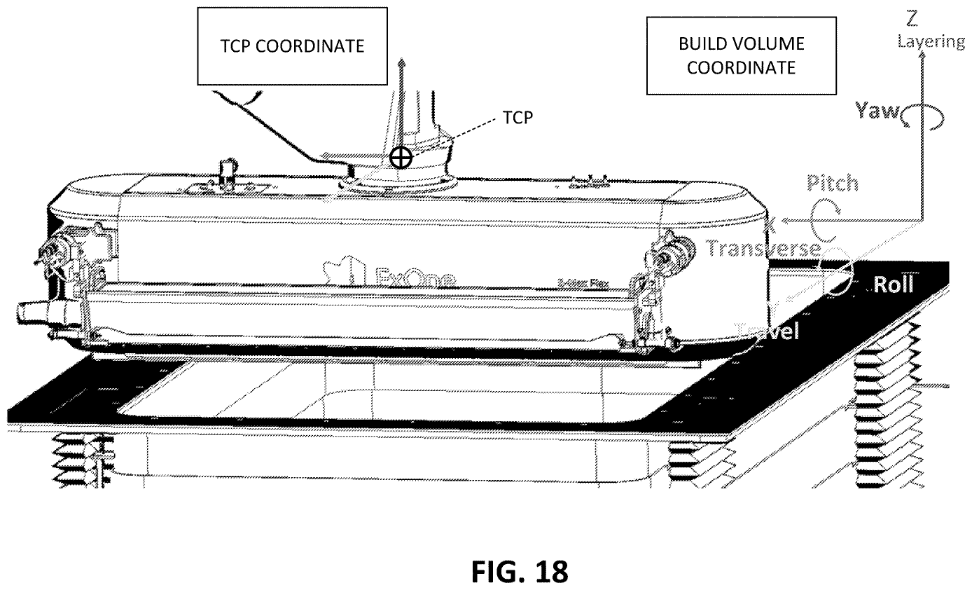

By way of example, this disclosure addresses deviations in the Z (vertical) axis near the beginning, middle, and end of the travel along the robot's Y axis. FIG. 18 describes errors in the Z-direction as “yaw” errors. Additionally, there are values that specify the size and location of a small, intentionally placed “bump” in the Z-axis of the robot path used for cancelling out a naturally occurring bump caused by backlash in the joints of the ABB IRB 460 and 660 robots. FIG. 3 provides an exaggerated illustration of this corrective profile. Such corrections are not just applicable to IRB 660 (IRB 4DOF robot), but can also be applied to 6DOF robots, where arbitrary pose correction can be applied per waypoint.

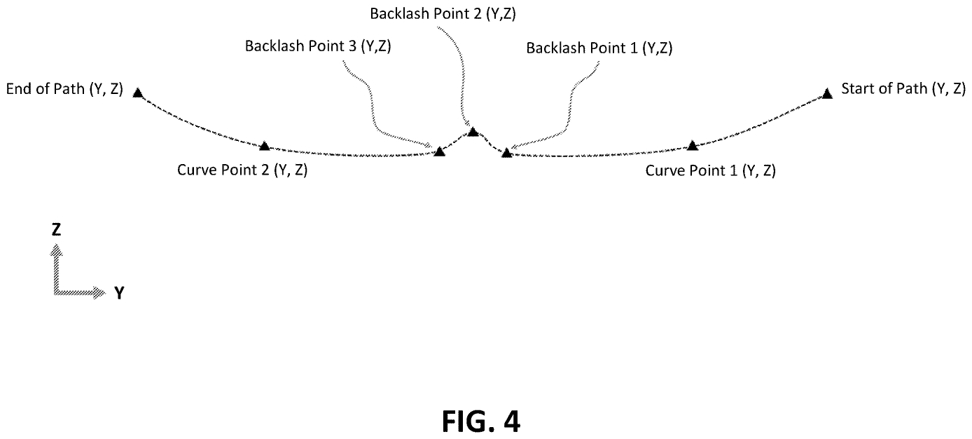

Many control points—such as X-, Y-, Z-, and theta-Z-deviations, as well as pose correction for 6DOF robots—may be added to correct for higher order polynomial behavior in movement. FIG. 4 shows a simple curved profile and a single high frequency back! ash occurrence.

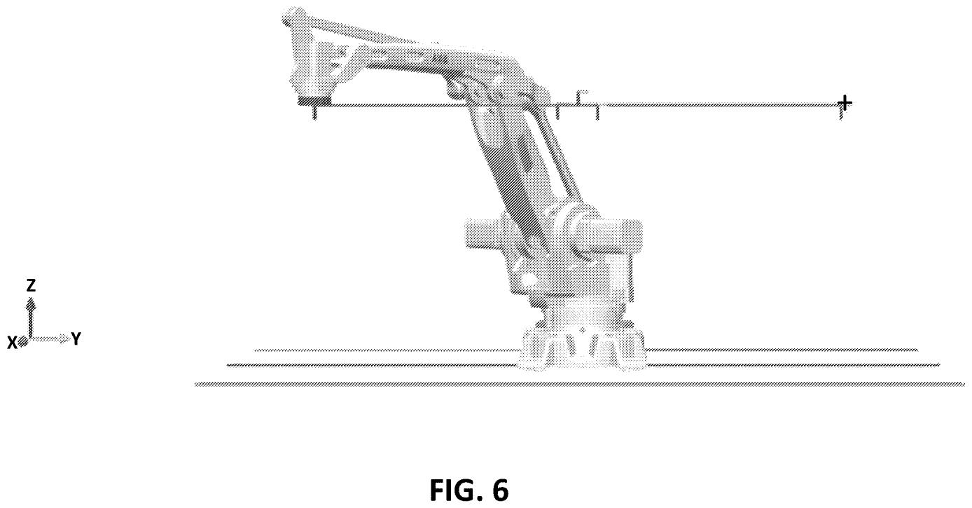

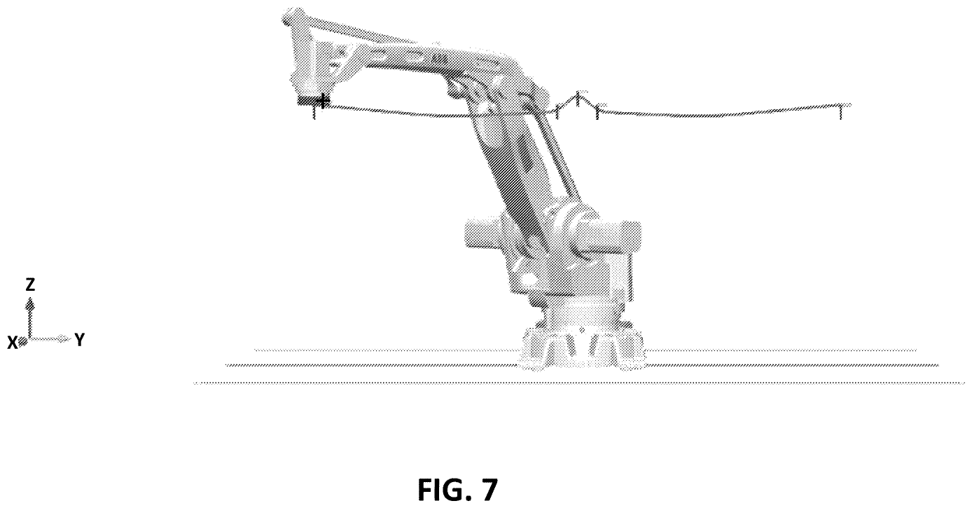

FIG. 5 shows an example of an early correction attempt while the robot, is commanded to undergo a test motion. The grey line is the original motion profile of the TCP, and the blue line is the same profile with the corrective Z offsets applied. A few hundred cycles of the test motion movement were recorded on different days under a variety of temperature conditions, and the corrective offsets were sufficient to maintain a consistent motion of the robot. It is therefore reasonable and sustainable to correct the movement of the IRB 660 in software to improve the linearity of the tool path. However, correction is nevertheless unique to each robot. FIG. 6 shows a robot's commanded path profile without correction, while FIG. 7 shows a robot's commanded path profile with correction.

FIG. 8 provides an example where different offsets were experimented with to achieve the straightest possible line. FIG. 8 only shows curvature correction-the backlash is still visible near the center of the print path. The data shown in FIG. 8 has not been skew-corrected.

This method for course correction of the robotic arm can serve to achieve near planarity in the Z-axis during movement in the X and Y plane. This near planarity can be described as no more than approximately 0.01 mm over 2500 mm distance in the X-Y plane or, for example, 0.015 mm.

Course correction such as the above can be implemented as part of a calibration routine for the robotic arm. For example, during machine initiation/setup from a manufacturer, or periodically during operation the robotic arm can be configured to perform one or more test motion tracks (e.g., full motion in X and/or full motion in Y) during which the average vertical variance is determined. Vertical Z-deviation can be determined using a straight edge of high flatness that is placed on top of a buildbox along the Y-axis. Such placement establishes reference planes in the X/Y and Y/Z planes. A linear measurement device affixed to an end-effector (laser distance or dial indicator) can be employed to quantify Z-deviation as a function of Y-position along a 2500 mm path trajectory. Linear measurement should be perpendicular to the X/Y plane with +/−2deg to minimize cosine error. The orientation of the reference plane need not be perfectly parallel to the TCP trajectory in the X/Y axis. The data collected should be skew-corrected, assuming the first and last data points are accurate. X-deviation along the path trajectory can be quantified similarly, with a linear measurement device oriented normal to the Y/Z plane of a reference object. If there are reference marks—or fiducials—positioned along the length of a straight edge at known positions, Y-deviation along the path can be quantified by examining the spatial distribution of peaks. Fiducials should be present on the Y/Z face of a reference object, so as not to be confused with any backlash hump in the Z-direction that also requires correction. Then, during operation, the robotic arm can be driven with the determined variation in the X-, Y-, Z- or theta-Z-axes to offset the determined variation and thereby achieve substantial planarity in movement across the X-Y axes. Path deviations only need to be measured once, and remeasured if the physical robot hard ware is repaired, overhauled, or otherwise mechanically modified. Full pose measurements are required for robots capable of 6DOF motion. Measurement scope can be simplified based on the nature of the error (i.e., what the dominant error contributions are).

In an alternative embodiment, variation in the X-, Y-, Z-, or theta-Z-axes, as well as pose error, can be observed and determined while the robotic arm is operating. That is, variation in the Z-axis can be measured as the machine is operating and compensated on one or more subsequent movements across the X-Y plane. Such on-the-fly course correction can be helpful as the machine wears over time or as loads on the print head vary during operation.

Path correction methods such as those described above are particularly relevant in the context of 3D printing or additive manufacturing. In a 3D printing embodiment, a robotic arm such as the IRB 660 can be part of a 3D printer. In certain embodiments, the 3D printer may utilize a powdered build material such as in the case of binder jet printing, or powder bed fusion, for example. Examples of build material powders include silica sand, quartz sand, and metal powders (which may be fine or coarse, according to certain embodiments). Binder jet printing is one type of additive manufacturing where a desired object is fabricated by the selective joining of a powdered build material using a binding agent. In embodiments utilizing the approach of binder jet printing, the robotic arm may be equipped with hardware for distributing a finely-divided (or powdered) build material within a build volume (such as sand or other material in powdered form), such as a sand hopper, a spreading apparatus to form a uniform layer exhibiting a flat surface of build material powder distributed in the build volume, and hardware for selectively depositing a binding agent on the surface of the uniform layer to at least partially form the desired object. Further, and according to certain embodiments, successive layers of build material powder may be deposited and spread along the surface of a build volume followed by further selective applications of the binding agent. The application of successive layers will require the indexing (change) in layering position of either the robot or the surface of the build volume to accommodate subsequent layers to fabricate a desired object. In successive layers increasing in depth in the Z-axis, a layer of sand (or other suitable build material powder) is spread across a print bed and a layer of binding material is selectively deposited upon the sand in a desired pattern. In certain embodiments, the binding material hardens in a shape forming a desired layer of a 3D printed object. Both the sand layer and the binding material layer can be spread by the robotic arm. After a layer of sand and binder is spread, the robotic arm moves upward in the Z-axis by a fixed nominal amount, and the process is repeated for successive layers. When the printing process is complete, and according to certain embodiments, the unbound sand is removed, revealing a 3D printed object. In certain embodiments, the binding material may harden, cure, react, crosslink, or otherwise enable hardening following drying, heating, or resting of a duration sufficient to enable hardening reactions to occur. Following the hardening of the object formed by successive deposition and binding steps, the object may be removed from any amount of remaining loose (or unbound) build material powder and utilized for further processing steps which may include thermal processing (debinding and sintering), or use as a mold for casting of molten materials, according to certain embodiments.

The motion of the robotic arm and end effector are particularly relevant in the context of binder jet 3D printing. Variation in position along the traverse of the robotic arm during the deposition and spreading of build material, in addition to the selective application of binding agent (or material), can lead to unacceptable variations in the geometric characteristics, mechanical performance, and generate appearance of the fabricated objects. In particular, the inventors of the present application recognize that binder placement error and corresponding part inaccuracy are crucial during the binder jet 3D printing process. Error in theta-Z direction may result in skewed imaging, even in situations where the TCP path is theoretically perfectly straight. Accordingly, consistency in the planarity of the path in the Z-direction as the print head moves in the X-and Y-axes must be maintained. Utilizing IRB 660 robotic arms, or the like, with the course correction of one or more embodiments of the present disclosure applied to its motion, achieves the goal of minimizing variation in the X-, Y-Z-, and theta-Z-axes while the arm moves across a print bed to deposit consistent layers of sand and/or binding material to form a 3D printed object.

The inventors of the application further recognize that variations in the mass of the end effector, including the microhopper containing an amount of powdered build material which varies during the course of the printing process, and such variation may adversely affect the deviation between the desired and realized path of the robot, end effector, and printing apparatus (including the microhopper, spreading apparatus, and printheads), In certain embodiments, it may be desirable to include sensing elements, devices, transduces, and the like within the end effector to monitor directly (using load cells, for example) or indirectly (using level sensors that may be capacitive, inductive, acoustic, contact, and the like) the mass (or a change in mass) of powdered build material being transited within the end effector by the robot. By tracking the mass (or the change in mass) of build material, compensation may be applied depending at least upon (1) the position of the robot, (2) the speed of the robot, and (3) a mass of powdered build material being conveyed by the robot within the end effector. In certain embodiments, it may be sufficient to dead reckon the mass of build material powder carried by the robot during printing by measuring or characterizing at least two of: (1) the starting mass of build material powder, (2) the ending mass of build material powder, and (3) the mass flux of build material powder to the build volume from the microhopper during printing and then utilizing the at least two characterized quantities to estimate the mass carried by the robot at each point and time and perform a correction for the mass carried. In certain embodiments, the at least two quantities may be characterized based upon a selected build material powder and a configuration of the deposition and spreading apparatus, such as may be done during initial commissioning of the printing system, or offsite in a research and development facility away from the point of use of the robotic printing system, for example.

A calibration procedure accounting for a changing mass of build material powder may further involve, according to certain embodiments, any of the calibration procedures previously described where a mass of payload conveyed by the robot within the end effector is varied during: the calibration procedure to establish a dependence of the trajectory upon the mass. Once the dependence of the trajectory upon the mass is obtained, calibration profiles may be generated to compensate for mass changes, according to certain embodiments.

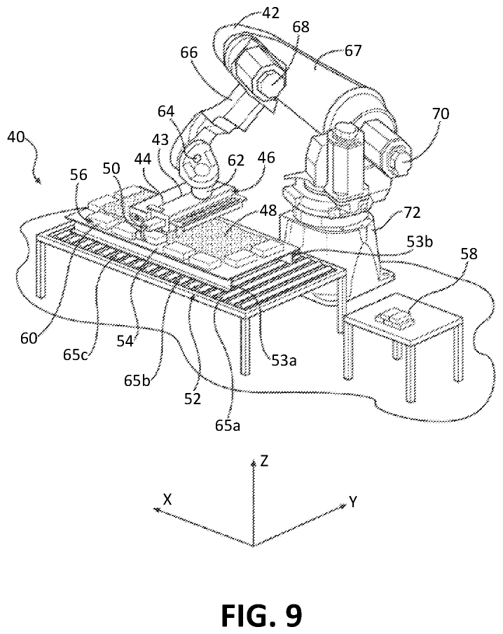

An exemplary implementation of a powder bed fusion 3D printing system in which the above-described robotic arm course correction could be implemented is described in U.S. Patent Publication No. 2018/0126668 to Ali El-Siblani, et al. (“El-Siblani”). El-Siblani discloses a robotic arm including a print engine 43, reproduced as FIG. 9. In FIG. 9, the X-Y-Z location of print head 43 is controlled by the rotational angle of base 72 and. the pivot point of arms 66 and 67 around the pivot shafts 68 and 70 respectively. However, movement in the X and Y axes by print head 43 should ideally be in a near constant plane across the Z-axis to maintain consistent distance from print head 43 to the printing powder base 48. Implementing the above-described course correction to the path of travel of the robotic arm formed by arms 66 and 67 would significantly improve the repeatability from build to build and the consistency from layer to layer of the deposition of sand and binding material from print head 43 on to the printing surface 48.

### Method to Quantify Pose Error at Each Waypoint

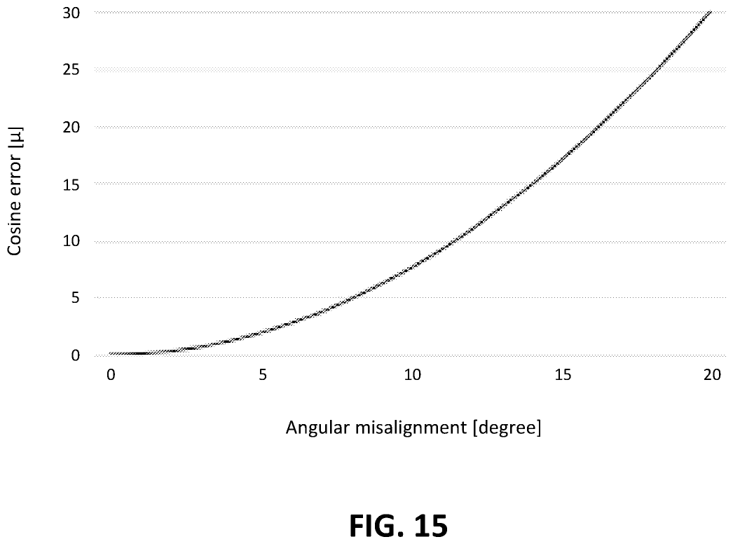

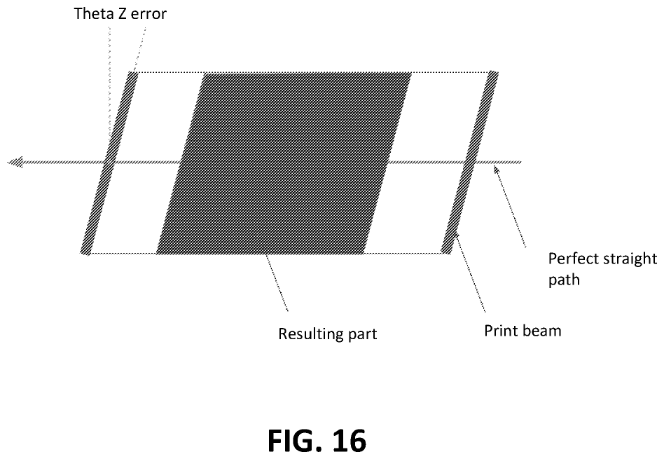

The corrections depicted in FIG. 15 relate to TCP straightness. During these corrections, the knuckle joint (where the kinematic attaches) rotates to maintain orientation of the printhead major axis (shown in FIG. 16) relative to an XYZ coordinate system of the robotic arm. This rotation is referred to as theta-Z rotation. The printhead's major axis should always be parallel to the X-axis throughout the corrective path. By way of example, if the path is straight but the printhead axis is misaligned, skewed parts will still be printed.

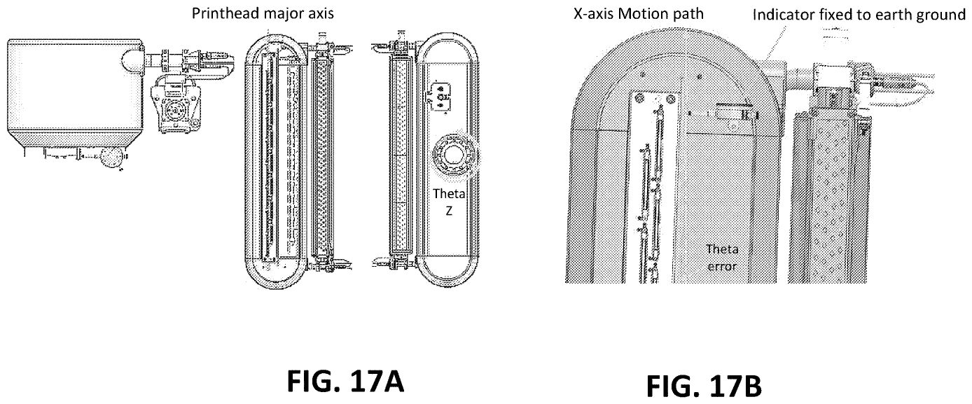

Theta Z errors can happen due to installation errors during kinematic mounting and repeatable motion errors in the wrist Joint throughout the layer trajectory. Theta Z errors can be quantified at each correction waypoint and theta Z correction applied similar to other XYZ position offsets. Error quantification can be performed by sweeping the printhead along the X-axis with the linear measurement device fixed to the ground and oriented to measure along the Y-axis at +/−2deg, as illustrated in FIGS. 17A-B. The spreader bar has a tolerance tight enough (+/−100 um profile) to be considered a reference object. Based on measurements along a sufficient distance (>500 mm), an angle can be calculated for the effective Theta Z error.

The following non-limiting embodiments for this disclosure are envisioned:

1. A method for course correcting a robotic arm printhead of a. three-dimensional printer comprising:
a. defining a trajectory of the robotic arm printhead across a build area of a three-dimensional printer;
b. directing the robotic arm printhead to travel across the defined trajectory;
c. observing the path of travel of the robotic arm printhead along the defined trajectory;
d. determining a deviation between the path of travel and the defined trajectory of the robotic arm printhead;
e. determining a course correction to counteract said deviation from the defined trajectory in travel., transverse, layering, and twist directions; and
f. modifying a subsequent path of travel for the robotic arm printhead across the build area of the three-dimensional printer by said course correction.

2. The method of embodiment 1, wherein the course correction is applied at multiple layers.

3. The method of embodiment 1, wherein the course correction is defined by a corrective path and comprises a path and backlash correction as a function of velocity.

4, The method of embodiment 2 wherein said course correction includes:
a. determining one or more curve points;
b. determining one or more backlash points;
c. calculating a first offset for each of the one or more curve points and backlash points from a plane normal to the travel direction;
d. calculating a second offset for each of the one or more curve points and backlash points from a plane normal to the transverse direction;
e. calculating a third offset for each of the one or more curve points and backlash points from a plane normal to the layering direction; and
f. defining a corrective path that offsets the deviation from the planar movement in the travel, transverse, and layering directions to account for the one or more curve points and backlash points.

5. The method of embodiment 4, wherein corrective path definition comprises offsets in twist direction

6. The method of embodiment 4, wherein the one or more backlash points lie in the layering direction, not the travel or transverse directions.

7. The method of embodiment 4, wherein correcting the one or more backlash points comprises:
a. quantifying backlash magnitude as a function of commanded tool center point (TCP) velocity; and
b. applying a correction based on the commanded TCP velocity.

8. The method of embodiment 1, wherein said course correction includes load-based layering direction compensation.

9. The method of embodiment 8, wherein said course correction includes:
a. measuring variations in print head mass via loadcells;
b. quantifying deviation in the layering direction as a function of applied load;
c. determining correction based on the quantified deviation from the layering direction; and
d. applying correction based on the quantified deviation from the layering direction to all path waypoints of the robotic arm printhead based on the measured variations.

10. The method of embodiment 1, wherein said course correction includes load-based compensation, the load-based compensation comprising gradient correction in the layering direction based on predicted load along a path.

11. The method of embodiment 10, wherein said course correction includes:
a. using loadcells to quantify mass-flowrate as a function of initial microhopper load; and
b. applying correction in the layering direction to each curve and backlash waypoint based on the initial microhopper load and predicted mass flow along a trajectory,

12. The method of embodiment 1, wherein said course correction includes using a reference object and device affixed to a print beam to quantify a path,

13. The method of embodiment 12, wherein said course correction includes:
a. making measurements of deviations from two axes along a print path orthogonal to a third axis;
b. analyzing data to extract the deviations from the two axes;
c. determining a number of path correction points; and
d. providing axes correction offsets for each waypoint of the robotic arm printhead based on the determined path correction points,

14. The method of embodiment 1, wherein said course correction includes:
a. measuring the pose error at each waypoint of the robotic arm printhead; and
b. correcting the pose error.

15. The method of embodiment 1, wherein, while being directed to travel across the defined trajectory, the robotic arm printhead deposits and spreads an amount of build material across the build area of the three-dimensional printer.

16. The method of embodiment 1, wherein determining a deviation between the path of travel and the defined trajectory of the robotic arm printhead comprises measuring a surface of a build material powder.

17. The method of embodiment 1, wherein the build material powder is sand.

18. A system for 3D printing comprising:
a. a robotic arm;
b. a print head; and
c. a print base; wherein the print head is attached to the robotic arm and moves in the travel, transverse, and layering directions across the print base; and
d. a path of the print head across the travel and transverse directions that is course corrected to maintain substantially planar movement in the layering direction and to minimize scale and form error along the trans verse and layering directions.

19. The system of embodiment 18, wherein the course correction is applied at multiple layers.

20. The system of embodiment 18, wherein the course correction is defined by a corrective path and comprises a path and backlash correction as a function of velocity.

21. The system of embodiment 18, wherein said course correction includes:
a. determining one or more curve points;
b. determining one or more backlash points;
c, calculating a first offset for each of the one or more curve points and backlash points from a plane normal to the travel direction;
d. calculating a second offset for each of the one or more curve points and backlash points from a plane normal to the transverse direction;
e. calculating a third offset for each of the one or more curve points and backlash points from a plane normal to the layering direction; and
f. defining a corrective path that offsets the deviation from planar movement in the travel transverse, and layering directions to account for the one or more curve points and backlash points.

22. The system of embodiment 21, wherein corrective path definition comprises offsets in twist direction.

23. The system of embodiment 21, wherein the one or more backlash points lie in the layering direction, not the travel or transverse directions.

24. The system of embodiment 21, wherein correction of the one or more backlash points is a function of commanded print velocity.

25. The system of embodiment 21, wherein correcting the one or more backlash points comprises:
a. quantifying backlash magnitude as a function of commanded tool center point (TCP) velocity; and
b. applying correction based on the commanded TCP velocity.

26. The system of embodiment 18, wherein said course correction includes load-based layering direction compensation.

27. The system of embodiment 26, wherein said course correction includes:
a. measuring variations in print head mass via loadcells;
b. quantifying deviation in the layering direction as a function of applied load;
c. determining correction based on the quantified deviation from the layering direction; and
d. applying correction based on the quantified deviation from the layering direction to all path waypoints of the robotic arm printhead based on the measured variations.

28. The system of embodiment 18, wherein said course correction includes load-based compensation, the load-based compensation comprising gradient correction in the layering direction based on predicted load along a path.

29. The system of embodiment 28, wherein said course correction includes:
a. using loadcells to quantify mass-flowrate as a function of initial microhopper load; and
b. applying correction in the layering direction to each curve and backlash waypoint based on the initial microhopper load and predicted mass flow along a trajectory.

30. The system of embodiment 18, wherein said course correction includes using a reference object and device affixed to a print beam to quantify a path.

31. The system of embodiment 30, wherein said course correction includes;
a. making measurements of deviations from two axes along a print path orthogonal to a third axis;
b. analyzing data to extract the deviations from the two axes;
c. determining a number of path correction points; and
d. providing axes correction offsets for each waypoint of the robotic arm printhead based on the determined path correction points.

32. The system of embodiment 18, wherein said course correction includes'
a. measuring the pose error at each waypoint of the robotic arm printhead; and
b. correcting the pose error.

33. A deposition assembly comprising:
a. a build material deposition/metering apparatus which deposits a build material powder onto a surface of an existing build material;
b. a build material spreading/leveling apparatus which spreads and levels the deposited build material powder within a build volume; and
c. a printhead which deposits a binding agent onto a surface of the build volume.

The deposition assembly of embodiment 33, wherein the build material powder is sand. Other examples of implementations will become apparent to the reader in view of the teachings of the present description and as such, will not be further described here.

Note that titles or subtitles may be used throughout the present disclosure for convenience of a reader, but in no way these should limit the scope of the present disclosure. Moreover, certain theories may be proposed and disclosed herein; however, in no way they, whether they are right or wrong, should limit the scope of the present disclosure invention so long as aspects of the present disclosure is practiced without regard for any particular theory or scheme of action.

All references cited throughout the specification are hereby incorporated by reference in their entirety for all purposes.

Reference throughout the specification to “some embodiments”, and so forth, means that a particular element (e.g., feature, structure, and/or characteristic) described in connection with the present disclosure is included in at least one embodiment described herein, and may or may not be present in other embodiments. In addition, it is to be understood that the described features may be combined in any suitable manner in the various embodiments.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this present disclosure pertains. In the case of conflict, the present document, including definitions will control.

As used in the present, disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although various embodiments of the disclosure have been described and illustrated, it will be apparent to those skilled in the art considering the present description that numerous modifications and variations can be made.

What is claimed is:

1. A method for course correcting a robotic arm printhead of a three-dimensional printer comprising:
defining a trajectory of the robotic arm printhead across a build area of a three-dimensional printer;
directing the robotic arm printhead to travel across the defined trajectory;
observing the path of travel of the robotic arm printhead along the defined trajectory;
determining a deviation between the path of travel and the defined trajectory of the robotic arm printhead;
determining a course correction to counteract said deviation from the defined trajectory in travel, transverse, layering, and twist directions; and
modifying a subsequent path of travel for the robotic arm printhead across the build area of the three-dimensional printer by said course correction.

2. The method of claim 1, wherein the course correction is applied at multiple layers.

3. The method of claim 1, wherein the course correction is defined by a corrective path and comprises a path and backlash correction as a function of velocity,

4. The method of claim 2 wherein said course correction includes:
determining one or more curve points;
determining one or more backlash points;
calculating a first offset for each of the one or more curve points and backlash points from a plane normal to the travel direction;
calculating a second offset for each of the one or more curve points and backlash points from a plane normal to the transverse direction;
calculating a third offset for each of the one or more curve points and backlash points from a plane normal to the layering direction; and
defining a corrective path that offsets the deviation from the planar movement in the travel, transverse, and layering directions to account for the one or more curve points and backlash points.

5. The method of claim 4, wherein corrective path definition comprises offsets in twist direction.

6. The method of claim 4, wherein the one or more backlash points lie in the layering direction, not the travel or transverse directions.

7. The method of claim 4, wherein correcting the one or more backlash points comprises:
quantifying backlash magnitude as a function of commanded tool center point (TCP) velocity; and
applying a correction based on the commanded TCP velocity.

8. The method of claim 1, wherein said course correction includes load-based layering direction compensation.

9. The method of claim 8, wherein said course correction includes:
measuring variations in print head mass via loadcells;
quantifying deviation in the layering direction as a function of applied load;
determining correction based on the quantified deviation from the layering direction; and
applying correction based on the quantified deviation from the layering direction to all path waypoints of the robotic arm printhead based on the measured variations.

10. The method of claim 1, wherein said course correction includes load-based compensation, the load-based compensation comprising gradient correction in the layering direction based on predicted load along a path.

11. The method of claim 10, wherein said course correction includes:
using loadcells to quantify mass-flowrate as a function of initial microhopper load; and
applying correction in the layering direction to each curve and backlash waypoint based on the initial microhopper load and predicted mass flow along a trajectory.

12. The method of claim 1, wherein said course correction includes using a reference object and device affixed to a print beam to quantify a path.

13. The method of claim 12, wherein said course correction includes:
making measurements of deviations from two axes along a print path orthogonal to a third axis;
analyzing data to extract the deviations from the two axes; c. determining a. number of path correction points; and
providing axes correction offsets for each waypoint of the robotic arm printhead based on the determined path correction points,

14. The method of claim 1, wherein said course correction includes:
measuring the pose error at each waypoint of the robotic arm printhead; and
correcting the pose error.

15. The method of claim 1, wherein, while being directed to travel across the defined trajectory, the robotic arm printhead deposits and spreads an amount of build material across the build area of the three-dimensional printer.

16. The method of claim 1, wherein determining a deviation between the path of travel and the defined trajectory of the robotic arm printhead comprises measuring a surface of a build material powder.

17. The method of claim 1, wherein the build material powder is sand.

18. A system for 3D printing comprising:
a robotic arm;
a print head; and
a print base; wherein the print head is attached to the robotic arm and moves in the travel, transverse, and layering directions across the print base; and
wherein the robotic arm is configured to move the print head in a path across the travel and transverse directions that is course corrected to maintain substantially planar movement in the layering direction and to minimize scale and form error along the transverse and layering directions.

19. (canceled)

20. (canceled)

21. The system of claim 18, wherein the system is configured to perform course correction comprising:
determining one or more curve points;
determining one or more backlash points;
calculating a first offset for each of the one or more curve points and backlash points from a plane normal to the travel direction;
calculating a second offset for each of the one or more curve points and backlash points from a plane normal to the transverse direction;
calculating a third offset for each of the one or more curve points and backlash points from a plane normal to the layering direction; and
defining a corrective path that offsets the deviation from planar movement in the travel, transverse, and layering directions to account for the one or more curve points and backlash points,
wherein correction of the one or more backlash points is a function of commanded print velocity.

22-32. (canceled)

33. A deposition assembly comprising:
a build material deposition/metering apparatus which deposits a build material powder onto a surface of an existing build material;
a build material spreading/leveling apparatus which spreads and levels the deposited build material powder within a build volume; and
a printhead which deposits a binding agent onto a surface of the build volume.

34. (canceled)
